(19) United States
(12) Patent Application Publication
(10) Pub. No.: US 2026/0340201 A1
(43) Pub. Date: Oct. 29, 2026

(54) CRYPTOGRAPHIC CIRCUIT AND METHOD

(71) Applicant: STMicroelectronics International N.V., Geneva (CH)

(72) Inventors: Simon Landry, Marseille (FR); Abdelmajid Douidi, Singapore (SG)

(21) Appl. No.: 19/642,700

(22) Filed: Apr. 9, 2026

(30) Foreign Application Priority Data
Apr. 23, 2025 (FR) FR2504312

(51) Int. Cl. G06F 21/72

(52) U.S. Cl. CPC G06F 21/72

(57) ABSTRACT

The present description concerns a circuit comprising: a memory configured to store a first state comprising N planes each comprising M lanes of L bits, where N, M, and L are integers greater than or equal to 2; a control circuit configured to order the memory to supply a first permuted plane of the first state to a cryptographic circuit, the first permuted plane comprising at least a first lane comprised in a first plane of the first state and a second lane comprised in a second plane of the first state different from the first plane, the cryptographic circuit configured to perform a cryptographic operation on the first state by generating an output state, the generation of the output state comprising the application of at least one transformation to the first permuted plane.

### CROSS-REFERENCE TO RELATED APPLICATIONS

This application claims priority to French Application No. FR2504312, filed on Apr. 23, 2025, which application is hereby incorporated herein by reference.

### TECHNICAL FIELD

The present disclosure generally concerns circuits for the implementation of post-quantum cryptographic operations.

### BACKGROUND

The KECCAK-p type family of algorithms operates on three-dimensional binary data, called “states”. This type of algorithms applies a sequence of confusion and diffusion operations on a state. The operation sequence is iterated a plurality of times, generally 24 times, in order to propagate the transformations. These cryptographic operations are for example used in the execution of hash functions, such as for example the SHA-3 hash functions and the SHAKE128 and SHAKE256 hash functions. In particular, these hash functions are used in post-quantum cryptography, for example in KYBER, also known as ML-KEM (FIPS 203) in the NIST standard, Dilithium, also known as ML-DSA (FIPS 204) in the NIST standard etc.

States being objects comprising more than one thousand bits, the application of a KECCAK-p type algorithm is computing time and hardware surface intensive. Indeed, the operations being at least partly performed on logic operations, a circuit configured to execute the algorithm comprises a large number of logic gates, which burdens the hardware implementation of the algorithm.

There exists a need to improve the hardware implementation of circuits configured to perform cryptographic operations on three-dimensional binary data. In particular, there exists a need to decrease the surface area of such circuits. There further exists a need to accelerate the execution of such algorithms.

### SUMMARY

An embodiment provides a circuit comprising: a memory configured to store a first state comprising N planes each comprising M lanes of L bits, where N, M, and L are integers greater than or equal to 2; a control circuit configured to order the memory to supply a first permuted plane of the first state to a cryptographic circuit, the first permuted plane comprising at least a first lane comprised in a first plane of the first state and a second lane comprised in a second plane of the first state different from the first plane, the cryptographic circuit configured to perform a cryptographic operation on the first state by generating an output state, the generation of the output state comprising the application of at least one transformation to the first permuted plane.

According to an embodiment, the control circuit is further configured to order, iteratively, the supply of N−1 other permuted planes of the first state to the cryptographic circuit, the cryptographic circuit being configured to generate, iteratively, the output state by further applying the at least one transformation to each of the N−1 other permuted planes.

According to an embodiment, the control circuit is configured to order the supply of a first permuted plane of the first state to the cryptographic circuit, based on an addressing of the lanes of the first state to the cryptographic circuit.

According to an embodiment, the first permuted plane corresponds to a plane of the first state to which a permutation transformation is applied.

According to an embodiment, the at least one transformation, applied to the first permuted plane, comprises: the generation of a first intermediate permuted plane, by performing a first transformation comprising, for each bit of the first permuted plane, the application of an EXCLUSIVE-OR (XOR) operation between the bit, a first parity bit, and a second parity bit, the first and second bits being comprised in a parity plane stored in the circuit; the generation of a second intermediate permuted plane by performing a second transformation comprising, for each lane of the first intermediate permuted plane, a shift based on a triangular value; the generation of a third intermediate permuted plane by performing a third transformation on each of the rows of the third intermediate permuted plane, the third transformation being a non-linear transformation; and the generation of a first plane of a second state by applying a fourth transformation corresponding to the addition of an integer value to the bits of at least one lane of the third intermediate permuted plane.

According to an embodiment, the cryptographic circuit (702) is further configured to generate the parity plane, based on the first state, by applying a parity operation to each column of the first state.

According to an embodiment, the at least one transformation applied by the cryptographic circuit is formed of the first, second, third, and fourth transformations.

According to an embodiment, integers N and M are equal to 5 and integer L is equal to 64.

According to an embodiment, the successive application of the first, second, third, and fourth transformations to each of the 5 planes of a state respectively corresponds to the application of the ρ, θ, χ, and ι transformations associated with cryptographic algorithms of the KECCAK-p family.

According to an embodiment, the first permuted plane corresponds to a first plane of the state to which the π transformation associated with cryptographic algorithms of the KECCAK-p family is applied.

According to an embodiment, each of the x-th lanes of each of the y-th planes of the first state, x and y being integer values between 0 and 4 and defining the coordinates of a lane in the first state, are each associated with an index value (I_{x,y}) equal to x+5y, the control circuit being configured to permute the lanes of the first state by addressing the lane of index (X+3Y)mod 5+5X for the processing of the Y-th lane of a X-th permuted plane, values X and Y being integer values between 0 and 4.

According to an embodiment, the memory, the control circuit, and the cryptographic circuit are configured to generate the output state by iterating a plurality of times, for example 24 times, the at least one transformation on the N planes of the state comprised in the memory.

According to an embodiment, the above circuit is further configured to generate a hash value over 256 or 384 or 512 or 1024 or 1536 bits based on the output state.

An embodiment provides a method comprising: the supply of a first permuted plane of a first state, stored in a memory, to a cryptographic circuit, the first state comprising N planes each comprising M lanes of L bits, where N, M, and L are integers greater than or equal to 2 and the first permuted plane comprising at least a first lane comprised in a first plane of the first state and a second lane comprised in a second plane of the first state different from the first plane; performing a cryptographic operation on the first state by the generation of an output state, by the cryptographic circuit, the generation comprising the application of at least one transformation to the first permuted plane.

According to an embodiment, the above method further comprises the generation of a hash value over 128 or 256 or 384 or 512 bits, based on the output state.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows a three-dimensional binary data item;

FIG. 2 is a flowchart showing steps carried out during the execution of a hash algorithm of the KECCAK-p family;

FIG. 3 is a diagram illustrating the transformations applied to a state by an algorithm of the KECCAK-p family;

FIG. 4 is a diagram illustrating the application of a first transformation on to plane of a state, according to an embodiment of the present disclosure;

FIG. 5 is a diagram illustrating the application of a second transformation to a plane of a state, according to an embodiment of the present disclosure;

FIG. 6 is a diagram illustrating the application of a third transformation to the planes of a state, according to an embodiment of the present disclosure;

FIG. 7 is a block diagram showing a circuit configured for the application of an algorithm of the KECCAK-p family, according to an embodiment of the present disclosure; and

FIG. 8 is a flowchart showing steps in the application of a hash function of the KECCAK-p family, according to an embodiment of the present disclosure.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the linear and non-linear transformations applied to a state for the implementation of a cryptographic algorithm of the KECCAK-p family are known to those skilled in the art and are not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

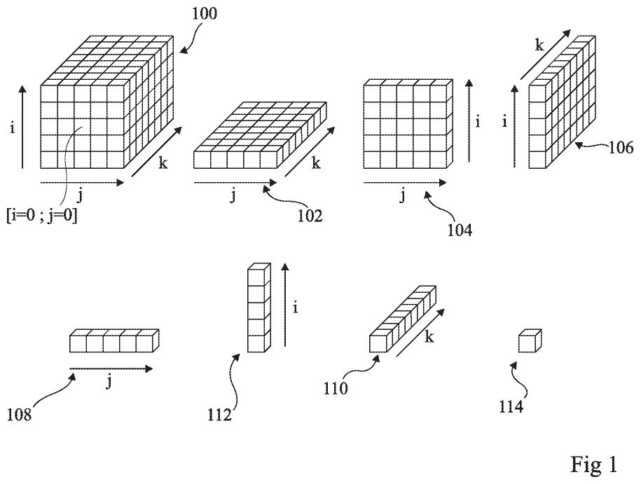

FIG. 1 schematically shows a three-dimensional binary data item, called “state”, 100. State 100 can be broken down into three two-dimensional binary objects. In particular, state 100 can be broken down into planes 102, slices 104, and sheets 106. Each of these two-dimensional binary objects can be broken down into a one-dimensional object. In particular, planes 102 can be broken down into rows 108 or into lanes 110. Slices 104 can be broken down into rows 108 or into columns 112 and sheets 106 can be broken down into columns 112 or into lanes 110. Each of these two-dimensional objects is formed of a plurality of bits 114.

As an example, a state comprises a number N of planes, a number M of slices, and a number L of sheets, numbers N, M, and L being integers greater than or equal to 2.

As an example, the algorithms of the KECCAK-p family are configured to be applied to 1,600-bit states. In particular, state 100 for example comprises 5 planes 102 of 320 bits, each plane 102 comprising either 5 lanes of 64 bits, or 64 rows 108 of 5 bits. State 100 may further be represented by 64 slices 106 of 25 bits, each slice 104 comprising 5 rows of 5 bits, or 5 columns of 5 bits. Similarly, state 100 may also be represented by 5 sheets 106 of 320 bits, each sheet 106 comprising 64 columns 112 of bits, or 5 lanes 110 of 64 bits. In other words, state 100 may for example be represented by a cube having a 5×5×64-bit size.

State 100 may further be represented by a three-dimensional binary table A (not illustrated in the drawings), for example having a 5×5×64 size, each element A[i,j,k], 0≤i,j≤4 and 0≤k≤63, in the table representing the status of the bit at position [i,j,k] in the state. As an example, A[:,j,k], 0≤j≤4 and 0≤k≤63, represents the column of state 100 comprising bits A[0,j,k] to A[4,j,k]. As an example, A[i,:,k], 0≤i≤4 and 0≤k≤63, represents the row comprising bits A[i,0,k] to A[i,4,k], 0≤i, j≤4 and 0≤k≤63. As an example, A[i,j,:], 0≤i,j≤4, represents the lane comprising bits A[i,j,0] to A[i,j,63]. Similarly, A[:,:,k], 0≤k≤63, represents the slice comprising bits A[0,0,k] to A[4,4,k]. Similarly, A[:,j,:], and A[i,:,:], 0≤i,j≤4 and 0≤k≤63, respectively represent the sheet comprising bits A[0,j,0] to A[4,j,63] and the plane comprising bits A[i,0,0] to A[i,0,63]. In particular, where position [0,0,k] ([i=0,j=0]) is the position of the bit at the center of slice A[:,:,k].

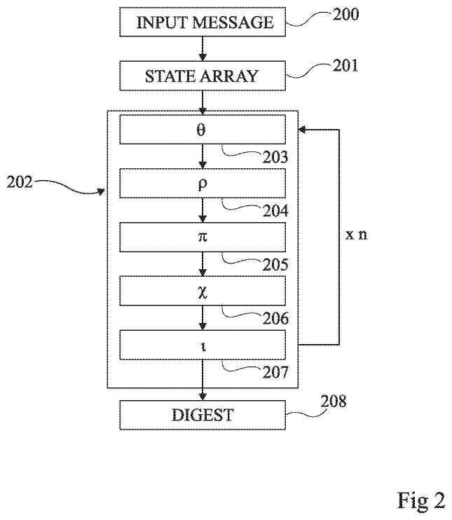

FIG. 2 is a flowchart showing steps carried out during the execution of a hash algorithm of the KECCAK-p family. In particular, the algorithm is iteratively executed on states such as described in relation with FIG. 1.

At a step 200 (INPUT MESSAGE), an input data item is supplied to a circuit configured to apply an algorithm of the KECCAK-p family.

The input data item is, for example, converted into an input state of 5×5×64 size at a step 201 (STATE ARRAY). As an example, the (64(5i+j)+k)^{th} bit of the input data item is sent to the position [i,j,k] of the input state, the calculation being performed modulo 5 for the positions on the rows and columns and modulo 64 for the lanes.

At a step 202, a plurality of linear transformations and one non-linear transformation are applied to the input state. In particular, step 202 comprises the application of a sequence of five transformations 203 to 207. Step 202 is iterated a plurality of times (x n), for example 24 times, on the states resulting from each application of the transformation sequence. The number of iterations corresponds to the number of turns in the KECCAK-p family algorithm. In particular, transformations 203 (θ), 204 (ρ), 205 (π), and 207 (ι) are information diffusion transformations. These transformations are linear transformations. Transformation 206 (χ) is a confusion transformation. In particular, transformation 206 is a non-linear transformation.

At the end of the plurality of iterations of step 202, an output state is generated. In particular, the output state is of same size as the input state of step 202. As an example, the output state is of 5×5×64 size.

At a step 208 (DIGEST), a hash value is generated from the output state. As an example, the hash value is a data item having a 224, 256, 384, or 512-bit size, according to the implemented hash function. As an example, if the hash function is an SHA-3 type function, the hash value is a value over 224, 256, 384, or 512 bits. In the example where the hash function is function SHAKE128, respectively function SHAKE256, the hash value is a variable and depends on the needs of the algorithm and/or the user. For example, the hash function is the SHAKE128 function or the SHAKE256 function used in the ML-KEM and ML-DSA algorithms. For example, for ML-KEM, the size of the SHAKE256 hash value is 1024 bits or 1536 bits. Each time the SHAKE256 function is executed, the hash value is, for example, 1344 bits. For example, to generate a hash value of 1024 bits, the SHAKE256 function is executed once. In another example, to generate a 1536-bit hash value, the SHA256 function is executed twice and the 1536-bit value is obtained on the basis of the two results. Generally speaking, in the ML-KEM algorithm, the SHAKE256 function is used and executed as many times as necessary to construct a hash value of arbitrary size.

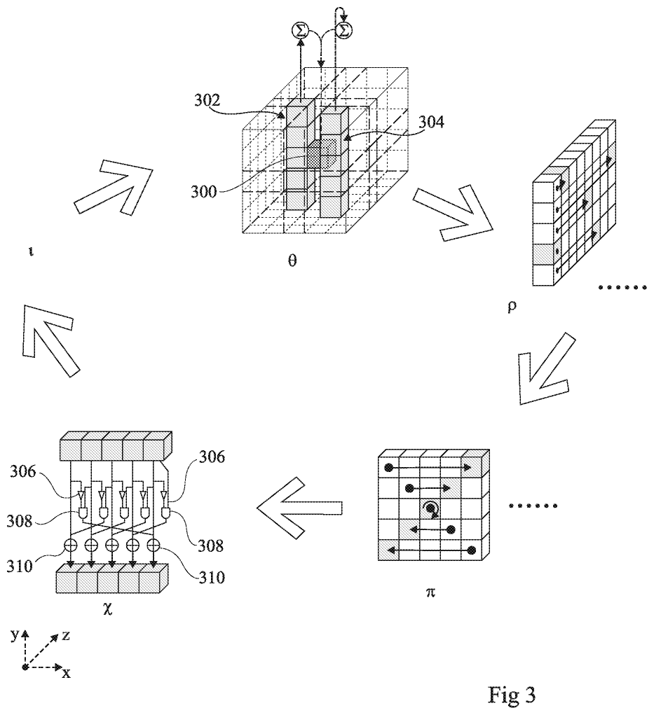

FIG. 3 is a diagram illustrating the transformations applied to a state by an algorithm of the KECCAK-p family. In particular, FIG. 3 illustrates the application of the sequence of transformations 203 to 207 of FIG. 2 to a state. The five transformations 203 to 207 are the standard transformations of the KECCAK algorithm and are known to those skilled in the art.

Transformation 203, commonly referred to as θ transformation, is a linear diffusion transformation. For each bit A[i,j,k] 300, 0≤i,j≤4 and 0≤k≤63, the θ transformation comprises the calculation of the parity of columns A[:,(j−1)mod 5;k] 302 and A[:,(j+1)mod 5;(k−1)mod 5] 304. The θ transformation further comprises the application of the EXCLUSIVE OR (XOR) operation between the parity of column A[:,(j−1)mod 5;k] and the parity of column A[:,(j+1)mod 5;(k−1)mod 64]. In other words, the application of the θ transformation to a state A results in a state A_{θ} where A_{θ}[i,j,k]=A[i,j,k]⊕parity (A[:,(j−1)mod 5;k])⊕parity (A[:,(j+1)mod 5;(k−1)mod 5]), and where parity is the parity function.

Transformation 204, commonly referred to as p transformation, is then applied to state A_{θ}. In particular, the p transformation is a transformation of circular dispersion on each sheet. Each bit on a lane of a slice of the state is shifted, modulo 64, by a shift value. As an example, the shift values are triangular numbers. In particular, the shift value applied to a lane A[i,j,:] is different from the shift values applied to each of the other lanes A[i′,j,:], where i≠i′. The shift on lane A[i,j,:] is, further, different from the shift applied to lanes A[i,j′,:], where j≠j′. In particular, the p transformation on a state A results in a state A_{ρ}, where A_{ρ}[i,j,k]=A[i,j, (k−(t+1)(t+2)/2)mod 64)], where t corresponds to the round number of the KECCAK-p family algorithm, for example between 0 and 23. In particular, the shift applied to each lane depends on its position in the state. The applied shift is determined by the following table, where the position (i=0,j=0) corresponds to the center of a slice.

TABLE 1

| | j = 3 | j = 4 | j = 0 | j = 1 | j = 2 |
|---|---|---|---|---|---|
| i = 2 | 153 | 231 | 3 | 10 | 171 |
| i = 1 | 55 | 276 | 36 | 300 | 6 |
| i = 0 | 28 | 91 | 0 | 1 | 190 |
| i = 4 | 120 | 78 | 210 | 66 | 253 |
| i = 3 | 21 | 136 | 105 | 45 | 15 |

Transformation 205, commonly referred to as π transformation, is a permutation of the elements in a same slice. In particular, the π permutation on a state A results in a state A_{π} where A_{π}[(3*i+2j)mod 5,i,k]=A[i,j,k], 0≤i,j≤4 and 0≤k≤63, where position [0,0,k] is the element at the center of a slice.

Transformation 206, commonly referred to as χ transformation, is a non-linear transformation corresponding to a diffusion. The χ transformation combines the elements of a row by using AND, NOT, and XOR logic operations between two bits. In particular, the χ permutation on a state A results in a state A_{χ}, where A_{χ}[i,j,k]=A[i,j,k]⊕((NOT A[i,(j+1)mod 5,k]) AND A[i,(j+2)mod 5,k]). For example, the hardware implementation of the χ transformation is performed, for each bit of each row, via a NOT gate 306 reading the value of the bit in column (j+1)mod 5 of this same row, an AND gate 308 between the output of gate 306 and the value of the bit in column (j+2)mod 5 of this same row, and an XOR gate 310 between the output of gate 308 and the bit in column j. The hardware cost for the implementation of the χ transformation on an entire state is then relatively high.

Transformation 207, commonly referred to as i transformation, is a linear transformation corresponding to an addition with a rounded value. In particular, the bits of the rounded value differ between each iteration of the KECCAK-p algorithm. Further, at each iteration, the rounded value is applied to a single plane of the state. As an example, the rounded value is based on a value comprised in a linear feedback shift register. The hardware implementation of the i function is based on a plurality of XOR gates and on at least one linear feedback shift register.

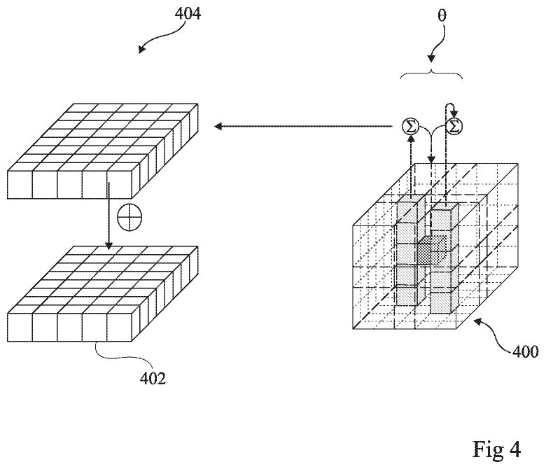

FIG. 4 is a diagram illustrating the application of the θ transformation to a plane 402 of a state A 400, according to an embodiment of the present disclosure. In particular, on each bit of the state a XOR operation is applied with the result of an XOR operation between the two neighboring columns of the state.

The θ transformation being performed based on the parity bits of neighboring columns, an embodiment comprises the calculation of a parity plane 404 comprising the parity values of each of the columns of state 400. As an example, parity plane 404 comprises 5*64=320 parity values. In particular, the value at position [i=k1,j=j1] of parity plane 404 is equal to the parity value of column A[:;j1,k1].

According to an embodiment, the application of the θ transformation is carried out plane by plane of state 400. As an example, for the plane 402 of state 400, the θ transformation is executed by applying the XOR operations, such as described in relation with FIG. 3, between each bit of plane 402 and the parity values of plane 404. In particular, for a given plane A[i,j,:], the XOR operation is executed between bit A[i,j,k1] and the values at positions [(j−1)mod 5,k1) and [(j+1)mod 5, (k1−1)mod 5] of plane 404. The operation is then repeated on each plane, for example on the 5 planes, of state 400, based on the same parity values of plane 404.

The θ transformation is applied to the 5 planes of the state 400. The result of this transformation then corresponds to the application of five XOR operations between the parity plane 404 and the five planes of state 400.

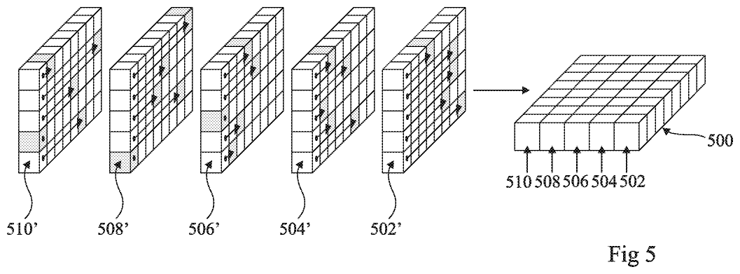

FIG. 5 is a diagram illustrating the application of the p transformation to a plane 500 of a state, according to an embodiment of the present disclosure. As an example, plane 502 is plane A[3,:,:].

As an example, for a lane 502 of plane 500, for example lane A[3,2,:], a shift 502′ is applied, for example a shift value of 15 is applied. The value of each bit A[3,2,k] is then shifted to the bit at position A[3,2,(k+15)mod 64]. Similarly, for a lane 504 of plane 500, for example lane A[3,1,:], a shift 504′ is applied, for example a shift value of 45 is applied. The value of each bit A[3,1,k] is then shifted to the bit at position A[3,1,(k+45)mod 64]. Similarly, for a lane 506 of plane 500, for example lane A[3,0,:], a shift 506′ is applied, for example a shift value of 105 is applied. The value of each bit A[3,0,k] is then shifted to the bit at position A[3,0,(k+105) mod 64]. Similarly, for a lane 508 of plane 500, for example lane A[3,4,:], a shift 508′ is applied, for example a shift value of 136 is applied. The value of each bit A[3,4,k] is then shifted to the bit at position A[3,4,(k+136)mod 64]. Similarly, for a lane 510 of plane 500, for example lane A[3,1,:], a shift 510′ is applied, for example a shift value of 21 is applied. The value of each bit A[3,1,k] is then shifted to the bit at position A[3,1,(k+21)mod 64]. The p transformation is thus applied, plane by plane of state, the shift values being applied for each lane of each plane being, for example, defined by the table [Table 1] introduced in relation with FIG. 3.

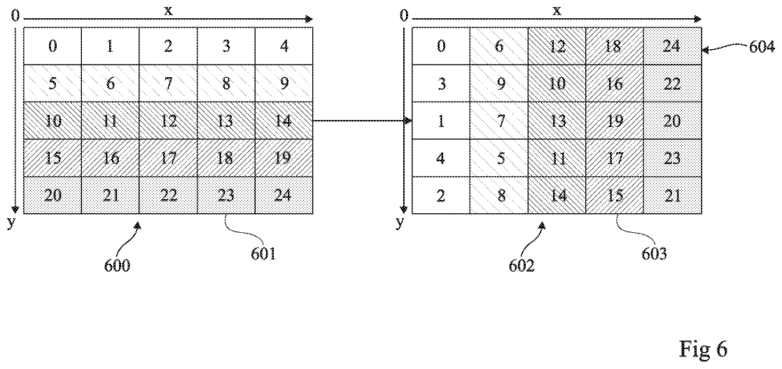

FIG. 6 is a diagram illustrating the application of the π transformation to the planes of a state 600, according to an embodiment of the present disclosure. As an example, state 600 is represented in the form of a table 601, each row representing a plane of state 600 and each box representing a lane of the plane of state 600. In this drawing, each box has as coordinates the coordinates (x,y) where box (0,0) is the box at the top left of table 601 and box (4,4) is the box at the bottom right of table 601. Thus, the first row of table 601 for example represents the plane A[2,:,:] of state 100 such as described in relation with FIG. 1. As an example, each lane of each plane is associated with an index value I between 0 and 24. In particular, each lane at position (x,y) of table 601 is associated with the index value I_{x,y} equal to x+5y. The π transformation, such as described in relation with FIG. 3 and when it is applied to all the planes of state 600, results in a new arrangement of the lanes within the planes. In particular, a permuted state 602, represented by a table 603, represented by the arrangement of the lanes within the planes of permuted state 602 as a result of the application of the π permutation to state 600. Each lane of state 602 has as coordinates the coordinates (X,Y) where box (0,0) is the box at the top left of table 603 and box (4,4) is the box at the bottom right of table 603. In particular, the π permutation is such that the lane associated with value I_{x,y} is sent to position [X=y,Y=(2x+3y)mod 5] of table 603. Thus, each box of coordinates (X,Y) of table 603 represents the lane associated with value [(X+3Y)mod 5]+5X. Thus, the 5 planes of permuted state 602 correspond to a rearrangement of the 25 lanes of state 600. For example, a new plane 604 of state 602 is formed of the lanes associated with integer values 0, 6, 12, 18, and 24.

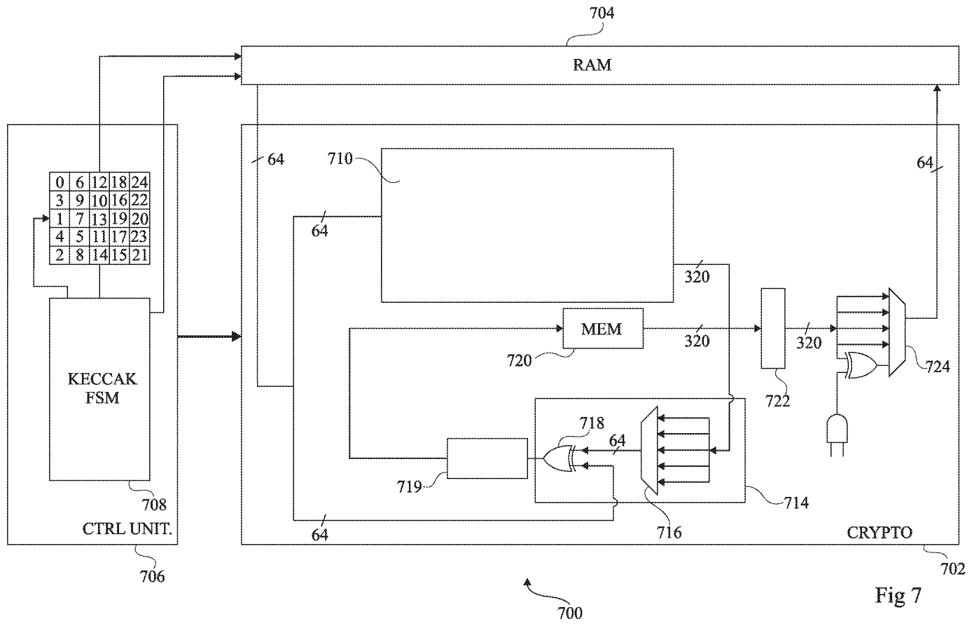

FIG. 7 is a block diagram showing a circuit 700 configured for the application of an algorithm of the KECCAK-p family, according to an embodiment of the present disclosure. In particular, circuit 700 is configured to apply the θ, ρ, χ, and ι transformations to a state, plane by plane. In particular, circuit 700 is configured to apply the θ, ρ, χ, and ι transformations to each plane of a state having already undergone the π transformation.

According to an embodiment, the π permutation is applied to a state upstream of the application of the other transformations. In particular, the application of the a transformation is performed on the addressing of the lanes of each plane to a cryptographic circuit 702 (CRYPTO) of circuit 700.

According to an embodiment, circuit 700 further comprises a memory 704 (RAM). As an example, memory 704 is a volatile memory, for example a random access memory (RAM). Circuit 700 further comprises a control circuit 706 (CTRL UNIT).

According to an embodiment, memory 704 is configured to receive states to which a KECCAK-p type algorithm is to be applied.

According to an embodiment, control unit 706 is configured to order memory 704 to supply cryptographic circuit 702 with planes having already undergone the π permutation. In particular, control unit 706 is configured to order memory 704 to supply planes of state 602 described in relation with FIG. 6. Control unit 706 is thus configured to modify for example via a finite-states machine 708 (KECCAK FSM), the addressing of each lane of a plane, so that each plane supplied to cryptographic circuit 702 has already undergone the π transformation, such as described in relation with FIG. 6. The θ and ρ transformations are thus applied to planes of a state having already undergone the π permutation. As an example, the supply of a first permuted plane is performed via the addressing of the lanes of index 0, 6, 12, 18, and 24. For example, the supply of a Y-th permuted plane, Y being an integer between 0 and 4, is performed via the addressing of the lanes of index [(X+3Y)mod 5]+5X, X∈{0, . . . , 4}.

Cryptographic circuit 702 comprises a parity circuit 710 configured to calculate the parity bits of the state stored in memory 704, such as described in relation with FIG. 4. In particular, parity circuit 710 receives as an input the permuted state, for example state 604. Based on a permuted state, parity circuit 710 is for example configured to store the parity bits, for example the 320 parity bits. In particular, the calculation of the parity plane of the permuted state is performed based on the non-permuted state stored in memory 704, via the addressing of the lanes, by control circuit 706, to cryptographic circuit 702. The circuit 710 is also configured to apply the XOR operation between the parity bits of neighboring columns.

Cryptographic circuit 702 further comprises a logic circuit 714 configured to execute the θ operation on each lane of the permuted plane supplied by memory 704, based on the parity values calculated by circuit 710. Logic circuit 714 for example comprises a multiplexer 716. The multiplexer 716 is configured to receive the 5 lane of the parity plane. Logic circuit 714 further comprises a circuit 718 configured to execute the XOR operation between each bit of the permuted plane and the parity bits. As an example, circuit 718 is configured to operate lane by lane and comprises, for example, 64 XOR-type logic gates. In particular, circuit 718 generates a first intermediate permuted plane.

Cryptographic circuit 702 further comprises a shift circuit 719 configured to execute the p transformation, such as described in relation with FIG. 5, on each lane generated by logic circuit 714. Shift circuit 718 is configured to store each generated lane in a memory volatile 720 (MEM). As an example, memory 720 comprises as many registers as planes forming the state, for example 5 registers. Each register is configured to store a lane of, for example, 64 bits. As a result of the processing of the 5 lanes of the first intermediate permuted plane by shift circuit 718, memory 720 stores a second intermediate permuted plane.

According to an embodiment, circuits 714 and 718 operate iteratively on each lane of a permuted plane. When all the lanes of a same permuted plane are processed, memory 720 supplies its content, for example, the 64 bits contained by each of the 5 registers, to a computing circuit 722. As an example, the 320 bits supplied by memory 720 correspond to the successive application of the θ and ρ transformations to a permuted plane.

Circuit 722 is configured to perform the χ transformation on the data item at the output of memory 720. As an example, circuit 722 comprises a plurality of logic AND-, NOT-, and XOR-type gates. In particular, circuit 722 is configured to generate a third intermediate permuted plane by applying the χ transformation such as described in relation with FIG. 3, to each row of the second intermediate permuted plane.

Cryptographic circuit 702 further comprises a multiplexer 724 configured to perform the i transformation on the output generated by circuit 722. Multiplexer 726 is configured to receive as many inputs as lanes forming a plane of the state, for example 5 inputs. As an example, one of the inputs of multiplexer 726 corresponds to a lane of the plane generated by circuit 722 to which is added an integer value in order to perform the i transformation. The other inputs of multiplexer 726 correspond to the other lanes of the plane generated by circuit 722. Multiplexer 724 is configured to generate an output plane by adding a rounding value to a lane of the third intermediate permuted plane. For example, memory 704 is sized in 64-bit words, corresponding to the size of the lanes. Read and write operations in memory 704 are performed word by 64-bit word. Once the output plan has been calculated and is ready to be stored in memory 704, the multiplexer 724 is configured to select, in order, lane by lane from the output plan in the correct order, and to store the lane one by one in memory 704.

Circuit 700 iterates the transformations on each of the planes of a state. A round of the KECCAK-p algorithm corresponds to the application of the transformations to each of the planes. In particular, once circuit 700 has processed all the planes of an input state, memory 704 comprises a first modified state formed of the output planes. This first modified state is then used as an input state for cryptographic circuit 702 so that the latter performs a new iteration of the algorithm of the KECCAK-p family.

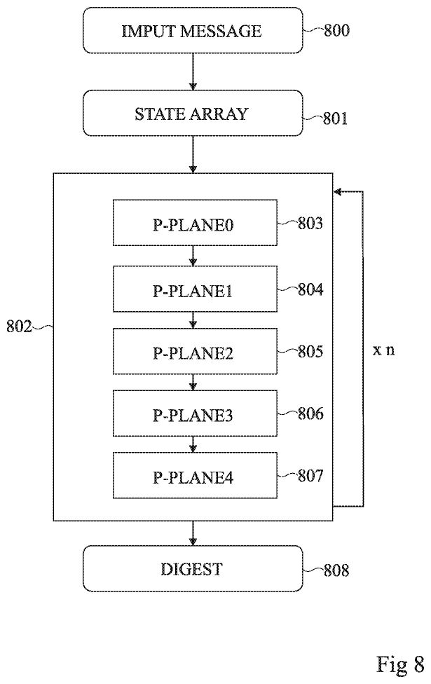

FIG. 8 is a flowchart showing steps in the application of a hash function of the KECCAK-p family, according to an embodiment of the present disclosure. In particular, the hardware implementation of the application of a hash function of the KECCAK-p family is achieved by circuit 700.

At a step 800 (INPUT MESSAGE), similar to the step 200 of FIG. 2, an input data item is supplied to circuit 700. The input data item is, for example, converted into an input state of 5×5×64 size at a step 801 (STATE ARRAY), similar to step 201. The input state is for example stored in memory 704.

At a step 802, circuit 700 generates an output state by applying the transformations described in relation with FIGS. 4, 5, 6, and 7. In particular, step 802 comprises 5 steps 803 to 807, each of these steps corresponding to the processing of a permuted plane of the state comprised in memory 704 by cryptographic circuit 702.

Step 803 (P-PLANE0) comprises the addressing, by control circuit 706, of the lanes forming a first permuted plane. Step 803 further comprises the processing, by the cryptographic circuit 702, of each lane of the first permuted plane. In particular, the addressing of the lanes forming the first permuted plane to circuit 702 is performed by control circuit 706 based on the state comprised in memory 704. In particular, the state comprised in memory 704 is not permuted, and corresponds for example to the input state. Thus, the π transformation is entirely implemented via control circuit 706 on the addressing of the lanes to cryptographic circuit 702. Similarly, step 804 (P-PLANE1), respectively steps 805 (P-PLANE2), 806 (P-PLANE3), and 807 (P-PLANE4), comprises the addressing, by control circuit 706, of the lanes forming a second permuted plane, respectively of the third, fourth, and fifth, permuted planes of the state stored in memory 704.

As a result of a first iteration of steps 803 to 807, a new state, corresponding to the state obtained as a result of the application of the θ, ρ, π, χ, and ι transformations to the input state, is stored in memory 704.

Step 802 is, for example, iterated a plurality of times ( ), for example 24 times, on the current state stored in memory 704. In particular, the parity plane is recalculated at each iteration of step 802, based on the current state stored in memory 704.

As a result of the plurality of iterations of step 802, an output state is generated. In particular, the output state is of same size as the input state of step 802. As an example, the output state is of 5×5×64 size.

At a step 808 (DIGEST), similar to step 208, a hash value is generated from the output state. As an example, the hash value is a data item having a 224, 256, 384, or 512-bit size, according to the implemented hash function. As an example, if the hash function is an SHA-3 type function, the hash value is a value over 224, 256, 384, or 512 bits. In the example where the hash function is function SHAKE128, respectively function SHAKE256, the hash value is a value of variable size, depending on the algorithm and/or user needs.

An advantage of the described embodiments is that the processing of a state is performed plane by plane, and not directly in its entirety. Thus, the surface area of circuit 700 is decreased.

Another advantage of the described embodiments is that the π permutation transformation is performed on the addressing of the lanes of each plane. Memory 702 then stores a non-permuted state and the permutation is performed via the addressing of the lanes to cryptographic circuit 702. Thus, the surface area of cryptographic circuit 702 is decreased since it comprises no components configured to perform this transformation.

Another advantage provided by the implementation of the π transformation via the addressing of the lanes is that the calculation time for performing the transformations is decreased.

Another advantage provided by the described embodiments is that circuit 700 is resistant Indeed, the processing of the states plane by plane, the implementation of the π transformation via the addressing of the lanes, and the application of the ρ and θ transformations to the already permuted planes are countermeasures to side-channel attacks. to side-channel attacks.

Various embodiments and variants have been described. Those skilled in the art will understand that certain features of these various embodiments and variants may be combined, and other variants will occur to those skilled in the art. In particular, the size of the states may vary. Although the example of states having 5×5×6 sizes is mainly described, those skilled in the art will be capable of adapting the embodiments of the present disclosure to states of different sizes. Similarly, the transformations performed by cryptographic circuit 702 may vary. The form of the π permutation may also vary, those skilled in the art will be capable of adapting the addressing of the lanes of each permuted plane according to the permutation to be performed.

Finally, the practical implementation of the described embodiments and variants is within the abilities of those skilled in the art based on the functional indications given hereabove.

What is claimed is:

1. A circuit comprising:
a memory configured to store a first state comprising N planes each comprising M lanes of L bits, where N, M, and L are integers greater than or equal to 2;
a control circuit configured to order the memory to supply a first permuted plane of the first state to a cryptographic circuit, the first permuted plane comprising at least a first lane comprised in a first plane of the first state and a second lane comprised in a second plane of the first state different from the first plane; and
the cryptographic circuit configured to perform a cryptographic operation on the first state by generating an output state, the generating of the output state comprising applying at least one transformation to the first permuted plane.

2. The circuit according to claim 1, wherein the control circuit is further configured to order, iteratively, the supply of N−1 other permuted planes of the first state to the cryptographic circuit, the cryptographic circuit being configured to iteratively generate the output state by further applying the at least one transformation to each of the N−1 other permuted planes.

3. The circuit according to claim 1, wherein the control circuit is configured to order the supply of the first permuted plane of the first state to the cryptographic circuit, based on an addressing of the lanes of the first state to the cryptographic circuit.

4. The circuit according to claim 1, wherein the first permuted plane corresponds to a plane of the first state to which a permutation transformation has been applied.

5. The circuit according to claim 1, wherein the at least one transformation, applied to the first permuted plane, comprises:
the generation of a first intermediate permuted plane, by performing a first transformation comprising, for each bit of the first permuted plane, the application of an EXCLUSIVE-OR (XOR) operation between the bit, a first parity bit, and a second parity bit, the first and second parity bits being comprised in a parity plane stored in the circuit;
the generation of a second intermediate permuted plane by performing a second transformation comprising, for each lane of the first intermediate permuted plane, a shift based on a triangular value;
the generation of a third intermediate permuted plane by performing a third transformation on each of the rows of the second intermediate permuted plane, the third transformation being a non-linear transformation; and
the generation of a first plane of a second state by applying a fourth transformation corresponding to the addition of an integer value to the bits of at least one lane of the third intermediate permuted plane.

6. The circuit according to claim 5, wherein the cryptographic circuit is further configured to generate the parity plane, based on the first state, by applying a parity operation to each column of the first state.

7. The circuit according to claim 5, wherein the at least one transformation applied by the cryptographic circuit is formed of the first, second, third, and fourth transformations.

8. The circuit according to claim 5, wherein integers N and M are equal to 5 and integer Lis equal to 64.

9. The circuit according to claim 8, wherein the successive application of the first, second, third, and fourth transformations to each of the 5 planes of the first state respectively corresponds to the application of the ρ, θ, χ, and ι transformations associated with cryptographic algorithms of the KECCAK-p family.

10. The circuit according to claim 8, wherein the first permuted plane corresponds to a first plane of the first state to which the π transformation associated with cryptographic algorithms of the KECCAK-p family is applied.

11. The circuit according to claim 8, wherein each of the x-th lanes of each of the y-th planes of the first state, x and y being integer values between 0 and 4 and defining the coordinates of a lane in the first state, are each associated with an index value (I_{x,y}) equal to x+5y, the control circuit being configured to permute the lanes of the first state by addressing the lane of index (X+3Y)mod 5+5X for the processing of the Y-th lane of a X-th permuted plane, values X and Y being integer values between 0 and 4.

12. The circuit according to claim 1, wherein the memory, the control circuit, and the cryptographic circuit are configured to generate the output state by iterating a plurality of times, for example 24 times, the at least one transformation on the N planes of the first state comprised in the memory.

13. The circuit according to claim 1, further configured to generate a hash value over 256 or 384 or 512 or 1024 or 1536 bits based on the output state.

14. A method comprising:
supplying a first permuted plane of a first state, stored in a memory, to a cryptographic circuit, the first state comprising N planes each comprising M lanes of L bits, where N, M, and L are integers greater than or equal to 2 and the first permuted plane comprising at least a first lane comprised in a first plane of the first state and a second lane comprised in a second plane of the first state different from the first plane; and
performing a cryptographic operation on the first state by generating an output state, by the cryptographic circuit, the generating comprising applying at least one transformation to the first permuted plane.

15. The method according to claim 14, further comprising the generation of a hash value over 128 or 256 or 384 or 512 bits, based on the output state.

16. The method according to claim 14, further comprising iteratively supplying N−1 other permuted planes of the first state to the cryptographic circuit, and iteratively generating the output state by further applying the at least one transformation to each of the N−1 other permuted planes.

17. The method according to claim 14, wherein the at least one transformation, applied to the first permuted plane, comprises:
generating a first intermediate permuted plane by performing a first transformation comprising, for each bit of the first permuted plane, application of an EXCLUSIVE-OR (XOR) operation between the bit, a first parity bit, and a second parity bit, the first and second parity bits being comprised in a parity plane stored in the circuit;
generating a second intermediate permuted plane by performing a second transformation comprising, for each lane of the first intermediate permuted plane, a shift based on a triangular value;
generating a third intermediate permuted plane by performing a third transformation on each of the rows of the second intermediate permuted plane, the third transformation being a non-linear transformation; and
generating a first plane of a second state by applying a fourth transformation corresponding to addition of an integer value to bits of at least one lane of the third intermediate permuted plane.

18. A circuit comprising:
a memory configured to store a first state comprising N planes each comprising M lanes of L bits, where N, M, and L are integers greater than or equal to 2;
a control circuit configured to supply a first permuted plane of the first state to a cryptographic circuit by addressing lanes of the first state stored in the memory, the first permuted plane corresponding to a plane of the first state to which a π permutation transformation associated with cryptographic algorithms of the KECCAK-p family is applied, the first permuted plane comprising at least a first lane comprised in a first plane of the first state and a second lane comprised in a second plane of the first state different from the first plane, wherein the memory stores the first state in a non-permuted form; and
the cryptographic circuit configured to generate an output state by applying, to the first permuted plane, a sequence of transformations comprising:
a first transformation comprising, for each bit of the first permuted plane, application of an EXCLUSIVE-OR operation between the bit and parity bits comprised in a parity plane;
a second transformation comprising, for each lane resulting from the first transformation, a shift based on a triangular value;
a third transformation comprising a non-linear transformation applied to each row resulting from the second transformation; and
a fourth transformation comprising addition of an integer value to bits of at least one lane resulting from the third transformation.

19. The circuit according to claim 18, wherein the control circuit is configured to supply the first permuted plane by addressing, for each lane position in the first permuted plane, a lane stored at a different plane position in the memory, such that the first permuted plane comprises lanes originating from at least two different planes of the first state stored in the memory.

20. The circuit according to claim 18, wherein the control circuit is further configured to iteratively order the supply of N−1 other permuted planes of the first state to the cryptographic circuit by addressing lanes of the first state stored in the memory, the cryptographic circuit being configured to iteratively generate the output state by further applying the sequence of transformations to each of the N−1 other permuted planes, and wherein the memory, the control circuit, and the cryptographic circuit are configured to generate the output state by iterating a plurality of times the sequence of transformations on the N planes of the first state comprised in the memory.
